(19) United States
(12) Patent Application Publication
(10) Pub. No.: US 2013/0219737 A1
(43) Pub. Date: Aug. 29, 2013

(54) RF Energy Application to Rotating Chambers

(71) Applicant: GOJI LTD., (US)

(72) Inventors: Steven R. Rogers, D.N. Emek Sorek (IL); Ben Zickel, Qiryat Bialik (IL); Avner Libman, Holon (IL)

(73) Assignee: GOJI LTD., Hamilton (BM)

(21) Appl. No.: 13/765,288

(22) Filed: Feb. 12, 2013

Related U.S. Application Data
(60) Provisional application No. 61/602,949, filed on Feb. 24, 2012.

(51) Int. Cl. F26B 3/347

(52) U.S. Cl. CPC F26B 3/347
USPC 34/255

(57) ABSTRACT

Some exemplary aspects of the invention may be directed to an apparatus for processing an object by RF energy applied at a plurality of excitation setups. The apparatus may include a controller configured to select one or more excitation setups, from among a plurality of pilot excitation setups, for applying RF energy to a rotating chamber; and cause a source of RF energy to apply RF energy at the one or more selected excitation setups, wherein the controller is configured to both select the one or more excitation setups and cause the source of RF energy to apply RF energy to the one or more selected excitation setups at least twice during a single rotation of the rotating chamber. The apparatus may be a dryer.

### RELATED APPLICATION

The present application claims priority to U.S. Provisional Patent Application No. 61/602,949, filed on Feb. 24, 2012, which is fully incorporated herein by reference.

### TECHNICAL FIELD

This patent application relating to a device and method for applying RF energy to rotating chamber; and more particularly but not exclusively to such devices and methods that make use of RF energy for drying objects inside the rotating chamber.

### BACKGROUND

Conventional dryers, including clothes dryers, typically operate by passing hot air through a rotating drying chamber. During its passage through the drying chamber, the hot air evaporates water from an object to be dried and increases in humidity.

### SUMMARY

Some exemplary aspects of the invention may be directed to a method of processing an object inside a rotating chamber. The method may include applying RF energy within the chamber (e.g., a drying chamber), which may be configured to contain the object and to rotate at a rotation frequency. The method may further include altering one or more aspects of the RF energy application at a change frequency. The change frequency may be higher than the rotation frequency.

In some embodiments, the method may include adjusting an amount of RF energy absorbed by the object by altering the one or more aspects of the RF energy application.

In some embodiments, the altering of one or more aspects of the RF energy application may be such that an energy absorption level within the chamber increases after the altering in comparison to an energy absorption level inside the chamber before the altering. An energy absorption level within the chamber may be calculated as an average value of an energy absorbed over a plurality of excitation setups applied or as a sum of amounts of energy absorbed during a certain time, for example, during 10, 20, or 50 msec.

Additionally, or alternatively, an energy absorption level within the chamber, during a period of time when the change frequency is higher than the rotation frequency, is at least 20% greater than an energy absorption level within the chamber when the change frequency is equal to the rotation frequency.

In some embodiments, altering the one or more aspects of the RF energy application may include changing a power level at which energy is applied to the chamber by a factor of at least 2.

In some embodiments, the application of RF energy to the chamber occurs at one or more excitation setups. In some such embodiments, altering the one or more aspects of the RF energy application may include changing at least one of the excitation setups.

In some embodiments, the application of RF energy may include: applying RF energy at a first power level at two or more pilot excitation setups, and applying RF energy at a second power level, higher than the first, at one or more selected excitation setups. The one or more selected excitation setups may include one or more of the pilot excitation setups.

In some embodiments, selecting the selected excitation setups from the pilot excitation setups may be based upon electromagnetic feedback associated with one or more of the pilot excitation setups.

In some embodiments, selecting the selected excitation setups from the pilot excitation setups may be in such a manner that each of the selected excitation setups is associated with an energy absorption efficiency higher than energy absorption efficiencies associated with pilot excitation setups not included in the one or more selected excitation setups.

Additionally, or alternatively, the selected excitation setups may be associated with RF energy absorption peaks having a Q factor less than 200.

In some embodiments, the one or more selected excitation setups may be associated with RF energy absorption peaks having a Q factor less than 200, and RF energy absorbable values in the object higher than RF energy absorbable values associated with pilot excitation setups that have a Q factor less than 200 and that are not included in the one or more excitation setups.

In some embodiments, the change frequency is higher than the rotation frequency by a factor of 10 or more, 15 or more, or 20 or more.

In some embodiments, a change in the selected excitation setups will take place if the rate of energy absorption in the object drops to 5% below its value associated with the previous change in the excitation setups.

An aspect of some embodiments of the invention may be directed to a method of drying, which may include: selecting, from among a plurality of excitation setups, one or more excitation setups for RF energy application to a rotating drying chamber configured to contain an object to be dried; and applying RF energy at the one or more selected excitation setups, wherein the selecting and applying occurs at least twice, at least 10 times, or at least 20 times, during a single rotation of the drying chamber.

In some embodiments, the selecting and applying occurs at least twice, at least 10 times, or at least 20 times, during each of at least half of the rotations of the rotating chamber.

In some embodiments, the method may further include receiving and/or detecting electromagnetic (EM) feedback from the chamber. In some such embodiments, the one or more excitation setups may be selected based on the EM feedback.

In some embodiments, the one or more excitation setups may be selected based on RF energy absorption characteristics of the object at the plurality of excitation setups. The energy absorption characteristics may include, for example, values indicative of energy absorbed in the object or in the cavity, for example, S parameters or other network parameters, dissipation ratios, reflection parameters, etc.

In some embodiments, the one or more selected excitation setups may have RF energy absorption levels higher than other excitation setups included in the plurality of excitation setups.

In some embodiments, the one or more selected excitation setups may have RF energy absorption levels higher than any of the other excitation setups of said plurality.

In some embodiments, selecting the one or more excitation setups may include causing application of RF energy at two or more pilot excitation setups; receiving EM feedback from the chamber; and selecting the one or more excitation setups from among the pilot excitation setups based on the EM feedback.

In some embodiments, causing application of RF energy at two or more pilot excitation setups may include applying RF energy at less than a first power level to the two or more pilot excitation setups; and applying the RF energy at the one or more selected excitation setups comprises applying RF energy at the selected excitation setups at a power level higher than a second power level that is higher than the first power level.

In some embodiments, the EM feedback may be indicative of an extent to which RF energy applied at the two or more pilot excitation setups can be absorbed in the chamber. For example, the EM feedback may indicate RF energy absorption characteristics. In some embodiments, energy absorption efficiency may be calculated from or form part of the RF feedback.

In some embodiments, the selected excitation setups may include those that, based on the EM feedback, exhibit energy absorbable values in the chamber greater than the pilot excitation setups not included in the one or more excitation setups.

In some embodiments, the one or more selected excitation setups may be associated with RF energy absorption peaks having widths greater than a predetermined threshold. In some embodiments, the threshold may correspond to a Q factor of 200 or less.

An aspect of some embodiments of the invention may include an apparatus configured to carry out a method as described above. For example, the apparatus may include a controller configured to carry out the method as described above.

For example, some embodiments may be directed to an apparatus for drying an object. The apparatus may include a source of RF energy and a controller. The controller may be configured to: cause the source of RF energy to apply RF energy within a chamber configured to hold the object and to rotate at a rotation frequency; and alter one or more aspects of the RF energy application to the chamber at a change frequency higher than the rotation frequency, for example, by a factor of 10.

In some embodiments, the controller may be configured to adjust an amount of RF energy absorbed by the object by altering the one or more aspects of the RF energy application to the chamber.

In some embodiments, the controller may be configured to alter one or more aspects of the RF energy application such that an energy absorption level inside the chamber increases after the altering in comparison to an energy absorption level inside the chamber before the altering.

In some embodiments, the controller may be configured to alter one or more aspects of the RF energy application such that an energy absorption level within the chamber, during a period of time when the change frequency is higher than the rotation frequency, is at least 20% greater than an energy absorption level within the chamber when the change frequency is equal to the rotation frequency.

In some embodiments, the controller may be configured to alter the one or more aspects of the RF energy application by changing a power level at which energy is applied to the chamber by a factor of at least 2.

In some embodiments, the controller may be configured to alter one or more aspects of the RF energy application, such that drying efficiency is larger by at least 10% than drying efficiency achieved with change frequency equal to the rotation frequency. In some embodiments, drying efficiency may be larger by 15%, 20%, or 25%.

Drying efficiency may be evaluated based on the amount of electrical energy required to bring the object to a target dryness level. In some embodiments, the target dryness level may be ambient humidity, such that an object having less moisture than allowed by the target dryness level will absorb moisture from the environment after drying. In some embodiments, the target moisture level may be a portion of the initial amount of moisture, for example, 40%, 50%, 70%, etc. of the initial moisture level. Increasing drying efficiency by 10%, for example, may mean decreasing the amount of energy required for reaching a target drying level by 10%.

In some embodiments, the source of RF energy may be configured to apply RF energy to the chamber at two or more excitation setups. Additionally, the controller may be configured to change one or more aspects of the two or more excitation setups at a change frequency higher than the rotation frequency.

In some embodiments, the controller may be configured to cause the source to apply RF energy at a first power level at two or more pilot excitation setups; select one or more of the pilot excitation setups; and cause the source to apply RF energy at the selected one or more excitation setups at a second power level higher than the first power level.

In some embodiments, an average absorption of energy applied at the selected excitation setups may be higher than an average absorption of energy applied at the two or more pilot excitation setups.

In some embodiments, the controller may be configured to select the one or more selected excitation setups from the pilot excitation setups based on energy absorption values associated with the one or more pilot excitation setups.

In some embodiments, the one or more selected excitation setups are associated with RF energy absorption peaks having a Q factor less than 200.

In some embodiments, the one or more selected excitation setups may be both associated with RF energy absorption peaks with a Q factor less than 200, and RF energy absorbable values in the object higher than RF energy absorbable values associated with pilot excitation setups that have a Q factor less than 200 and that are not included in the one or more excitation setups.

An aspect of some embodiments of the invention may include a drying apparatus, comprising a source of RF energy, and a controller. The controller may be configured to select one or more excitation setups, from among a plurality of pilot excitation setups, for applying RF energy to a rotating drying chamber; and cause the source of RF energy to apply RF energy at the one or more selected excitation setups, wherein the controller is configured to select the one or more excitation setups and cause the source of RF energy to apply RF energy at the one or more selected excitation setups at least twice, at least 10 times, or at least 20 times during a single rotation of the rotating drying chamber.

In some embodiments, the controller may be configured to select the one or more excitation setups and cause the source of RF energy to apply RF energy to the one or more selected excitation setups at least twice during at least half of the rotations of the drying chamber.

In some embodiments, the controller may be configured to both select the one or more excitation setups and cause the source of RF energy to apply RF energy at the one or more selected excitation setups at least twice, at least 10 times, or at least 20 times during at least half of the rotations of the drying chamber.

In some embodiments, the controller may be further configured to detect and/or receive electromagnetic (EM) feedback from the drying chamber and select the one or more excitation setups based on the EM feedback.

In some embodiments, the controller may be configured to select the one or more excitation setups based on RF energy absorption characteristics associated with the plurality of excitation setups.

In some embodiments, the one or more selected excitation setups are each associated with RF energy absorption levels higher than RF energy absorption levels of other excitation setups of said plurality of pilot excitation setups not among the one or more selected excitation setups.

In some embodiments, the controller may be configured to: cause application of RF energy at two or more pilot excitation setups; receive EM feedback from the chamber; and select the one or more selected excitation setups from among the pilot excitation setups based on the EM feedback.

In some embodiments, the controller may be configured to cause application of RF energy at the two or more pilot excitation setups at less than a first power level and apply the RF energy at the one or more selected excitation setups at a second power level that is higher than the first power level.

In some embodiments, the EM feedback may be indicative of an extent to which RF energy applied at each of the plurality of pilot excitation setups can be absorbed in the chamber.

In some embodiments, the controller may be configured to select the one or more excitation setups based on whether the one or more excitation setups are associated with RF energy absorption peaks having widths greater than a predetermined threshold.

The drawings and detailed description which follow contain numerous alternative examples consistent with the invention. A summary of every feature disclosed is beyond the object of this summary section. For a more detailed description of exemplary aspects of the invention, reference should be made to the drawings, detailed description, and claims, which are incorporated into this summary by reference.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a diagrammatic representation of an apparatus for applying electromagnetic energy to an object, in accordance with some exemplary embodiments of the present invention;

FIG. 2 is a view of a cavity, in accordance with some exemplary embodiments of the present invention;

FIG. 3 is a diagrammatic representation of an apparatus for applying electromagnetic energy to an object, in accordance with some exemplary embodiments of the present invention;

FIGS. 4A and 4B are flow charts illustrating methods of drying, in accordance with some embodiments of the invention; and

FIG. 5 is a diagrammatic representation of a laundry dryer according to some embodiments of the invention.

### DETAILED DESCRIPTION

In some respects, the invention may involve apparatuses and methods for applying RF energy. The term RF energy, as used herein, includes energy deliverable by electromagnetic radiation in the RF portion of the electromagnetic spectrum, which includes radiation with a wavelength in free space of 100 km to 1 mm, which corresponds to a frequency of 3 KHz to 300 GHz, respectively. In some examples, the applied RF energy may fall within frequency bands between 10 MHZ to 100 GHz, 500 MHz to 1500 MHz or between 700 MHz to 1200 MHz or between 800 MHz-1 GHz. As used herein, RF wave may refer to electromagnetic wave having a frequency in the RF portion of the electromagnetic spectrum. Microwave and ultra high frequency (UHF) energy, for example, are both within the RF range. In some other examples, the applied RF energy may fall only within one or more ISM frequency bands, for example, between 433.05 and 434.79 MHz, between 902 and 928 MHz, between 2400 and 2500 MHz, and/or between 5725 and 5875 MHz.

An apparatus according to some embodiments of the invention may include one or more energy application units. An energy application unit may include one or more radiating elements and an RF energy source configured to supply RF energy to the radiating element(s). In some embodiments, an energy application unit may include two or more synchronized RF energy sources, which may be controlled to feed the radiating elements with signals having a common frequency. The signals may be fed at a controlled phase difference, at a controlled amplitude difference, etc. In some embodiments, energy may be applied from each of the energy application units individually (e.g., seriatim) or, alternatively, energy may be applied concurrently from two or more of the energy application units. In some embodiments application from the energy application units individually may result in the same or similar processing effects as applying energy from two or more of the radiating elements concurrently. Therefore, a similar discussion may be relevant both to apparatuses including one energy application unit and to apparatuses including a plurality of energy application units, and the invention may be implemented irrespective of the number of energy application units included in the apparatus.

An energy application unit according to some embodiments may apply energy at two or more different excitation setups. Applying energy at different excitation setups may result in excitation of different field patterns in the energy application zone. The excitation setups may differ from one another by one or more values of parameters that may affect the field pattern and may be controlled by components of the apparatus. Such a parameter is referred to herein as a controllable field affecting parameter (c-FAP). In some embodiments, a value may be selected for each c-FAP, and the excitation setup may be defined by the selected values. Varying a selected value of even one c-FAP varies the excitation setup, which, in turn, may vary the field pattern excited in the energy application zone.

In some cases, varying values of c-FAPs may result in significant variations in the generated field patterns. In other instances, however, varying values of c-FAPs may produce little or no change in the generated field patterns (e.g., if the variation between the two values of the c-FAP is small).

As an analogy, an excitation setup, and how it may be set with respect to the energy application unit of the disclosed embodiments, may be viewed as similar, or analogous to, setting the controls of a switchboard that includes a set of knobs, dials, switches, or other value-selectors. In the switchboard case, switching from one setup to another may be accomplished by manipulating one (or more) of the value-selectors. Each unique set of values associated with the value-selectors may result in a different control setup. In other words, the position of all the value selectors collectively (e.g., the positions of all the knobs, dials and switches collectively) may define a single control setup.

Similarly, in the presently disclosed embodiments, an energy application unit may supply RF energy at one or more c-FAPs, and an energy excitation setup may be defined based on the values of a set of c-FAPs. Changing from one excitation setup to another may be accomplished by changing the values associated with one (or more) of the c-FAPs. Each unique set of c-FAP values may result in a unique excitation setup. In some embodiments, the energy application unit may be controlled by a processor, and the values of the available c-FAPs may be set using micro-switches, transistors, electronic circuitry, or any other value selectors.

Applying energy at a particular excitation setup may excite an electromagnetic field pattern in the energy application zone. For brevity, this excited electromagnetic field pattern may be referred to as an excitation. Thus, each excitation setup may correspond to an excitation; and a reference to a supply, reception, absorption, leaking, etc. of an excitation setup may refer to a supply, reception, absorption, leaking, etc. of the corresponding excitation. Thus, for example, a statement that a given excitation or excitation setup is absorbed in the object may mean that energy associated with an electromagnetic field excited by the energy application unit at the given excitation setup is absorbed in the object.

Various apparatuses may be used to control field affecting parameters. For example, in some embodiments, an apparatus may include a controller that controls the frequency of an electromagnetic wave applied by an energy application unit to the energy application zone. In such apparatuses, the frequency may be available as a controllable field affecting parameter (c-FAP). In one example, such an apparatus may control the frequency to have any of two or more values, e.g. 800 MHz, 800.5 MHz, etc. By controlling the frequency and changing from one frequency value to another, the excitation setup may be changed, which, in turn, may change an electromagnetic field pattern excited in the energy application zone.

In another example, an energy application unit may include two radiating elements that emit radiation at a controllable phase difference. The phase difference may be controlled to have two or more values, e.g., 0°, 90°, 180°, or 270°. The phase difference between electromagnetic fields emitted by the two radiating elements may be available to the apparatus comprising the energy application unit as a c-FAP.

In another example, a difference between intensities at which two radiating elements emit electromagnetic fields of the same frequency may be controlled, and thus may be available as a c-FAP.

In another example, an energy application zone may include one or more conductive elements (e.g., rods), each of which may be controlled to be either in a parasitic state or in a connected state. The value of the state of each rod (i.e. parasitic or connected) may affect the electromagnetic field pattern excited in the energy application zone. In apparatuses having such rods, the state of each rod may constitute a c-FAP.

In another example, an energy application zone may include a magnetizable element (e.g., at a wall of the energy application zone) and an electromagnet near the magnetizable element. The magnetizable element and the electromagnet may be arranged such that a field pattern excited in the energy application zone may be affected by current flowing in the electromagnet. In embodiments where this current is controllable, the value of the current (e.g., 1 mA, 20 mA, 500 mA, etc.) may be available as a c-FAP.

In another example, an energy application unit may include a plurality of radiating elements, and each may be turned on or off. In such embodiments, the status of each radiating element (i.e., on or off) may be available as a c-FAP. Additionally, or alternatively, the total number of radiating elements turned on may constitute a c-FAP.

Other examples of parameters that may serve as controllable field affecting parameters in some embodiments may include the position of a radiating element, orientation of a radiating element, position and/or orientation of conducting elements in the energy application zone, cavity dimensions, or any other controllable parameter, the value of which may affect a field pattern excited in the energy application zone upon RF energy application to the zone.

Excitation setups including only a single c-FAP may be referred to as one-dimensional excitation setups. An excitation setup including multiple c-FAPs may be referred to as a multi-dimensional excitation setup. For example, an apparatus configured to control the state of each of six rods to be either parasitic or connected may have a six-dimensional excitation setup. Two examples of such excitation setups may be: (parasitic, parasitic, parasitic, connected, connected, connected), and (parasitic, connected, connected, parasitic, parasitic, connected). In general, the number of c-FAPs available to an apparatus determines a dimension of the excitation setups available to the apparatus. The collection of all the excitations that may be excited by an apparatus (or the collection of all the excitation setups available to an apparatus) may be referred to as the excitation space of the apparatus. The dimension of an excitation space of an apparatus may be the same as the dimension of each excitation setup available to that apparatus.

In some embodiments, an energy application unit may be controlled by a processor configured to control energy application in accordance with feedback. The feedback may be indicative, for example, of the temperature, weight, position, volume, or any other characteristic of the object. Additionally, or alternatively, the feedback may include electromagnetic feedback.

As used herein, EM feedback may include any received signal or any value calculated based on one or more received signals, which may be indicative of the dielectric response of the cavity and/or the object to electromagnetic fields excited in the cavity. For example, EM feedback may include input and output power levels, network parameters, e.g., S parameters, Y parameters, reflection and transmission coefficients, impedances, etc, as well as values derivable from them. Examples of derivable values may include dissipation ratios (discussed below), time or excitation setup derivatives of any of the above, etc. EM feedback may be excitation-dependent, for example, may include signals, the values of which vary over different excitation setups. Therefore, electromagnetic feedback measured when energy is applied at various excitation setups may be used for controlling energy application selectively at the various excitation setups.

Thus, in some embodiments, energy application may be controlled such that one or more aspects of energy application at a given excitation setup (e.g., amount of energy, power level at which energy is applied, time duration at which energy is applied etc.) may depend on electromagnetic (EM) feedback received. The EM feedback received may be associated with one excitation or multiple excitations, and, in some embodiments, the EM feedback received may be associated with an excitation other than an excitation that caused the EM feedback.

As used herein, if a machine (e.g., a processor) is described as configured to perform a task (e.g., configured to cause application of a predetermined field pattern), then it is to be understood that the machine includes the components or elements (e.g., parts, software, etc.) needed to make the machine capable of performing the described task during operation. In some embodiments, the machine may also perform the task during operation. Similarly, when a task is described as being done in order to establish a target result (e.g., in order to increase energetic efficiency), such a discussion associates the task with the target result. In some embodiments, the target result may be fully or partially accomplished through performing the task.

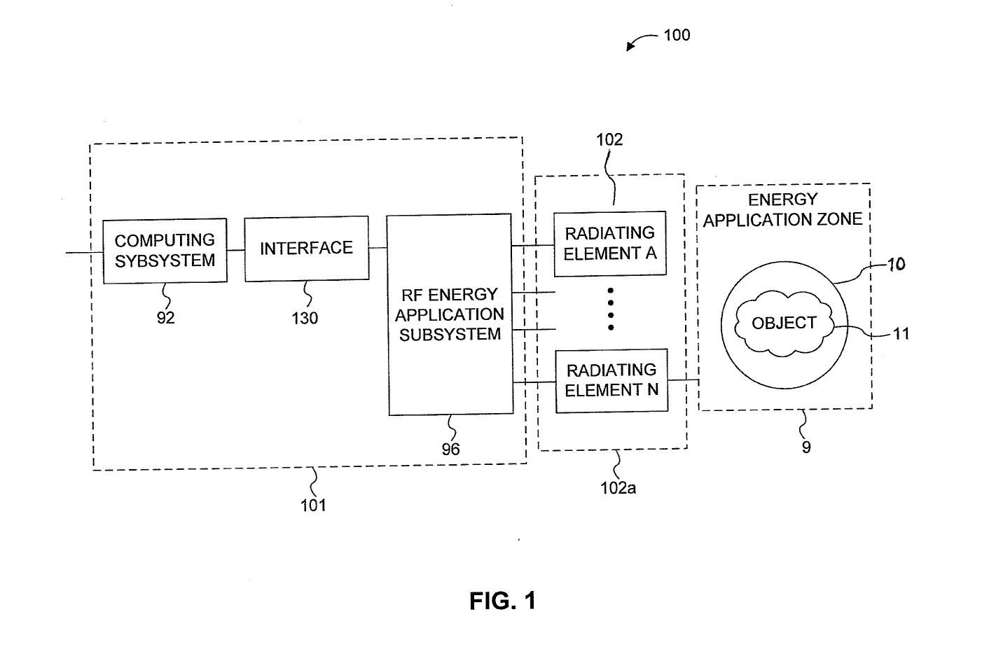

FIG. 1 is a diagrammatic representation of an apparatus 100 for applying electromagnetic energy to an object placed in energy application zone 9. Energy application zone 9 may include any void, location, region, or area where electromagnetic energy may be applied. In some embodiments, energy application zone 9 may include an RF-transparent chamber 10 (also referred to herein as rotating chamber or drying chamber), which may be configured to receive an object to be processed (e.g., dried) and to rotate inside zone 9. Energy application zone 9 may include an interior of an enclosure that allows existence, propagation, and/or resonance of RF waves. For purposes of this disclosure, all energy application zones may alternatively be referred to as cavities.

The RF transparent chamber may be made of RF transparent material. RF transparent material may include any material capable of transferring at least some EM energy in the RF range. Some examples of RF transparent materials may include: glass, such as tempered soda-lime glass (also known as PYREX), heat resistant polymers, such as Silicone, etc.

Apparatus 100 may include a controller 101, an array 102a of radiating elements 102 (e.g., antennas) including one or more radiating elements, and energy application zone 9. Controller 101 may be electrically coupled to one or more radiating elements 102. As used herein, the term “electrically coupled” refers to one or more either direct or indirect electrical connections. Controller 101 may include a computing subsystem 92, an interface 130, and an RF energy application subsystem 96. Based on an output of computing subsystem 92, energy application subsystem 96 may respond by generating one or more radio frequency signals to be supplied to radiating elements 102. In turn, the one or more radiating elements 102 may radiate electromagnetic energy into energy application zone 9 and more particularly, into chamber 10. In certain embodiments, this energy can interact with object 11 positioned within energy application zone 9 (inside chamber 10).

Consistent with the presently disclosed embodiments, computing subsystem 92 may include a general purpose or special purpose computer. Computing subsystem 92 may be configured to generate control signals for controlling RF energy application subsystem 96 via interface 130. Computing subsystem 92 may further receive measured signals from electromagnetic energy application subsystem 96 via interface 130.

While controller 101 is illustrated for exemplary purposes as having three subcomponents, control functions may be consolidated in fewer components, or additional components may be included consistent with the desired function and/or design of a particular embodiment.

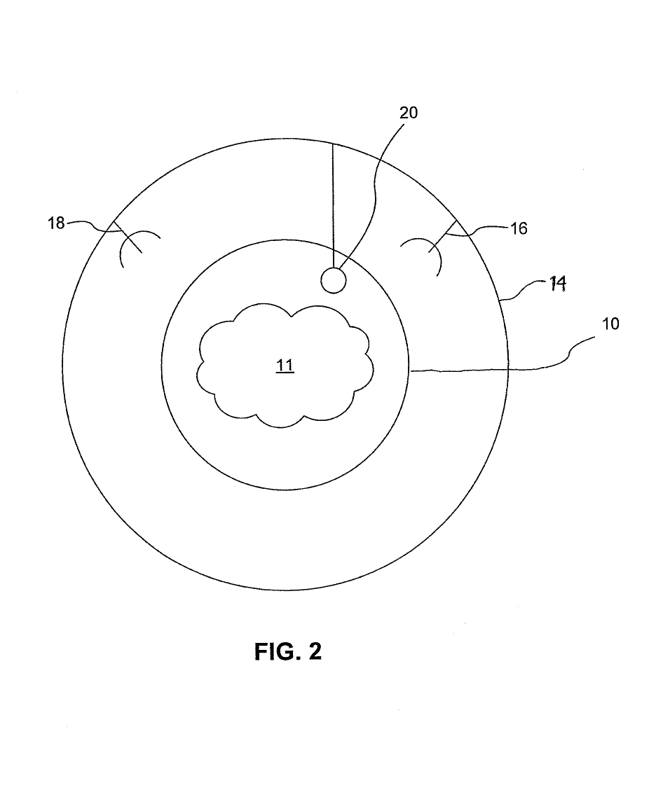

FIG. 2 shows a sectional view of a cavity 14, which is one exemplary embodiment of energy application zone 9. Cavity 14 may be cylindrical in shape (or any other suitable shape, such as spherical, rectangular, cuboid, etc.) and may be made of a conductor, such as aluminum, stainless steel or any suitable metal or other conductive material. In some embodiments, cavity 14 may include walls coated and/or covered with a protective coating. The coating may be made, for example, from materials transparent to RF energy, e.g., metallic oxides or others. Cavity 14 may be resonant in a predetermined range of frequencies (e.g., within the UHF or microwave range of frequencies, such as between 300 MHz and 3 GHz, or between 400 MHz and 1 GHZ). The general methodology of the invention is not limited to any particular cavity shape or configuration, as discussed earlier. FIG. 2 shows a sensor 20 and radiating elements 16 and 18 (examples of radiating elements 102 shown in FIG. 1).

Additionally, one or more sensor(s) or detector(s) 20 may be used to sense or detect information (e.g., signals) relating to object 11 and/or to the energy application process and/or the energy application zone. At times, one or more radiating elements, e.g., radiating element 16, or 18, may be used as sensors, in addition to sensor 20 or in absence of sensor 20. The sensors may be used to sense any information, including electromagnetic power, temperature, weight, humidity, motion, etc. The sensed information may be used for any purpose, including process control, verification, automation, safety, etc.

Automation may be affected, for example, by adjusting aspects of the RF energy application based on an output from the sensor(s). For example, drying may be stopped or adjusted once the sensor(s) indicate that certain stopping or adjusting criteria are met. For example, in some embodiments, once a humidity level around the object reaches a predetermined threshold, or once the object loses a predetermined portion of its weight, drying through application of RF energy may be stopped or adjusted.

As represented by FIG. 1, apparatus 100 may include at least one radiating element 102 in the form of at least one antenna for delivery of electromagnetic energy to energy application zone 9. One or more of the radiating elements may also be configured to receive electromagnetic energy from energy application zone 9. In other words, a radiating element, as used herein may function as a transmitter, a receiver, or both, depending on a particular application and configuration.

As used herein, the terms “radiating element” and “antenna” may broadly refer to any structure from which electromagnetic energy may radiate and/or be received, regardless of whether the structure serves any additional function. For example, a radiating element or an antenna may include an aperture/slot antenna, or an antenna which includes a plurality of terminals transmitting in unison, either at the same phase or at a controlled dynamic phase difference (e.g., a phased array antenna). Consistent with some exemplary embodiments, radiating elements 102 may include an electromagnetic energy transmitter (referred to herein as “a transmitting antenna” or “emitting radiating element” or “transmitter”) that feeds RF energy into electromagnetic energy application zone 9, an electromagnetic energy receiver (referred herein as “a receiving antenna” or “receiver”) that receives RF energy from zone 9, or a combination of both a transmitter and a receiver. For example, a first radiating element may be configured to deliver (apply) electromagnetic energy to zone 9, and a second radiating element may be configured to receive energy from the first radiating element. In some embodiments, one or more radiating elements may each serve as both receivers and transmitters. In some embodiments, one or more radiating elements may serve a dual function while one or more other radiating elements may serve a single function. So, for example, a single antenna may be configured to both deliver electromagnetic energy to the zone 9 and to receive electromagnetic energy from the zone 9; a first antenna may be configured to deliver electromagnetic energy to the zone 9, and a second antenna may be configured to receive electromagnetic energy via the zone 9; or a plurality of antennas could be used, where at least one of the plurality of antennas may be configured to both deliver electromagnetic energy to zone 9 and to receive electromagnetic energy via zone 9. At times, in addition to or as an alternative to delivering and/or receiving energy, an antenna may also be adjusted to affect the field pattern. For example, various properties of the antenna, such as position, location, orientation, etc., may be adjusted. Different antenna property settings may result in differing electromagnetic field patterns within the energy application zone thereby affecting energy absorption in the object. Therefore, antenna adjustments may constitute one or more variables that can be varied for energy application control.

Consistent with the presently disclosed embodiments, energy may be supplied and/or provided to one or more transmitting antennas. Energy supplied to a transmitting antenna may result in energy emitted by the transmitting antenna (referred to herein as “incident energy”). The incident energy may be delivered to zone 9, and may be in an amount equal to an amount of energy supplied to the transmitting antenna(s) by a source. A portion of the incident energy may be dissipated in the object or absorbed by the object (referred to herein as “dissipated energy” or “absorbed energy”). Another portion may be reflected back to the transmitting antenna (referred to herein as “reflected energy”). Reflected energy may include, for example, energy reflected back to the transmitting antenna due to mismatch caused by the object and/or the energy application zone, e.g., impedance mismatch. Reflected energy may also include energy retained by the port of the transmitting antenna (e.g., energy that is emitted by the antenna but does not flow into the zone). The rest of the incident energy, other than the reflected energy and dissipated energy, may be coupled to one or more receiving antennas other than the transmitting antenna (referred to herein as “coupled energy.”). Therefore, the incident energy (“I”) supplied to the transmitting antenna may include all of the dissipated energy (“D”), reflected energy (“R”), and coupled energy (“C”), and may be expressed according to the relationship:

I=D+R+C.

In accordance with certain aspects of the invention, the one or more transmitting antennas may deliver electromagnetic energy into zone 9. Energy delivered by a transmitting antenna into the zone (referred to herein as “delivered energy” or (d)) may include the incident energy emitted by the antenna minus the reflected energy at the same antenna. That is, the delivered energy may be the net energy that flows from the transmitting antenna to the zone, i.e., d=I−R. Alternatively, the delivered energy may also be represented as the sum of dissipated energy and coupled energy, i.e., d=D+C (where C=ΣCᵢ).

In certain embodiments, the application of electromagnetic energy may occur via one or more power feeds. A feed may include one or more waveguides and/or one or more radiating elements (e.g., radiating elements 102) for applying electromagnetic energy to the zone. Such radiating elements may include, for example, patch antennas, fractal antennas, helix antennas, log-periodic antennas, spiral antennas, slot antennas, dipole antennas, loop antennas, slow wave antennas, leaky wave antennas or any other structures capable of transmitting and/or receiving electromagnetic energy.

In certain embodiments, there may be provided at least one processor. As used herein, the term “processor” may include an electric circuit that performs a logic operation on input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations. The at least one processor may be coincident with or may be part of controller 101.

The instructions executed by the processor may, for example, be pre-loaded into the processor or may be stored in a separate memory unit such as a RAM, a ROM, a hard disk, an optical disk, a magnetic medium, a flash memory, other permanent, fixed, or volatile memory, or any other mechanism capable of storing instructions for the processor. The processor(s) may be customized for a particular use, or can be configured for general-purpose use and can perform different functions by executing different software.

If more than one processor is employed, all may be of similar construction, or they may be of differing constructions. Further, the processors may be electrically connected together or they may be electrically isolated from one another. They may be separate from one another or may be integrated together. When more than one processor is used, they may be configured to operate independently or collaboratively. They may be coupled electrically, magnetically, optically, acoustically, mechanically or by other means permitting them to interact.

The at least one processor may be configured to cause electromagnetic energy to be applied to zone 9 via one or more radiating elements, for example across a series of excitation setups in order to apply electromagnetic energy at each such excitation setup to an object 11. For example, the at least one processor may be configured to regulate one or more components of controller 101 in order to cause energy to be applied.

In certain embodiments, the at least one processor may be configured to determine a value indicative of energy absorbable by the object, also referred to herein as an RF energy absorption level, at each of a plurality of excitation setups. This may occur, for example by testing an object in an energy application zone to determine its absorbable energy characteristics. One exemplary way to conduct such a test is through a sweep.

As used herein, a sweep may include, for example, the transmission over time of energy at two or more excitation setups. For example, a sweep may include the sequential transmission of energy at multiple excitation setups in one or more contiguous excitation setup band; the sequential transmission of energy at multiple excitation setups in more than one non-contiguous excitation setup band; the sequential transmission of energy at individual non-contiguous excitation setups; and/or the transmission of synthesized pulses having a desired frequency band/power spectral content (e.g., a synthesized pulse in time). The excitation setup bands may be contiguous or non-contiguous. Excitation setups or excitation setup bands may be considered contiguous if they are contiguous along one or more c-FAPs. For example, a band of one-dimensional excitation setups composed of frequency values only, may be considered contiguous if the frequency values of successive excitation setups in the band have contiguous values. A band of two-dimensional excitation setups, composed of frequency values and phase values, may be considered contiguous if the frequency values of successive excitation setups in the band have contiguous values, and/or if the phase values of successive excitation setups in the band have contiguous values. Thus, during an excitation setup sweeping process, the at least one processor may regulate the energy supplied to the at least one antenna to sequentially deliver electromagnetic energy at various excitation setups to zone 9, and to receive feedback which serves as an indicator of the energy absorbable by object 11. While the invention is not limited to any particular measure of feedback indicative of energy absorbable in the object, various exemplary indicative values are discussed below.

During the sweeping process, electromagnetic energy application subsystem 96 may be regulated to receive electromagnetic energy reflected and/or coupled at radiating elements(s) 102, and to communicate the measured energy information (e.g., information pertaining to and/or related to and/or associated with the measured energy) back to computing subsystem 92 via interface 130, as illustrated in FIG. 1. Computing subsystem 92 may then be regulated to determine a value indicative of energy absorbable by object 11 at each of a plurality of excitation setups based on the received information. Consistent with some of the presently disclosed embodiments, a value indicative of the absorbable energy may include a dissipation ratio (referred to herein as “DR”) associated with each of a plurality of excitation setups. As referred to herein, a “dissipation ratio” (or “absorption efficiency” or “power efficiency”), may be defined as a ratio between electromagnetic energy absorbed in energy application zone 9 with object 11 therein, and electromagnetic energy supplied to the radiating element. In some embodiments, a dissipation ratio may be defined as a ratio between electromagnetic energy absorbed in energy application zone 9 with object 11 therein, and electromagnetic energy delivered to zone 9. The delivered energy may be defined as the difference between the energy supplied to a radiating element and the energy reflected back to the radiating element.

Energy that may be dissipated or absorbed by an energy application zone comprising an object is referred to herein as “absorbable energy” or “absorbed energy”. Absorbable energy may be an indicator of the object's capacity to absorb energy or the ability of the apparatus to cause energy to dissipate in a given object, or the extent to which the applied RF energy can be absorbed in the chamber. A value indicative of energy absorbable in the object may be also said to be indicative of the energy absorbed in the object.

In some of the presently disclosed embodiments, absorbable energy may be calculated as a product of the incident energy supplied to the at least one radiating element and the dissipation ratio. Reflected energy (e.g., the energy not absorbed or coupled) may, for example, be a value indicative of energy absorbed by the object. By way of another example, a processor might calculate or estimate absorbable energy based on the portion of the incident energy that is reflected and the portion that is coupled. That estimate or calculation may serve as a value indicative of absorbed and/or absorbable energy.

During an excitation setup sweep, for example, the at least one processor may be configured to control a source of electromagnetic energy such that energy is sequentially applied to an object at a series of excitation setups. The at least one processor might then receive a signal indicative of energy reflected at each excitation setup and, optionally, also a signal indicative of the energy coupled to other radiating elements at each excitation setup. Using known or measured amounts of incident energy supplied to the radiating element at each excitation setup and measuring the amount of energy reflected and/or coupled at each excitation setup, a value indicative of energy absorbable in the object may be calculated or estimated.

Absorbable energy may also include energy that may be dissipated by the structure of the energy application zone in which the object is located (e.g., cavity walls) or leakage of energy at an interface between a cavity and its door. Because absorption in metallic or conducting material (e.g., the cavity walls or elements within the cavity, e.g., metal elements within a cloth to be dried, such as: buttons, zippers, coins, etc.) is characterized by a large quality factor (also known as a “Q factor”), excitation setups associated with absorption peaks having a large Q factor (e.g., larger than 200) may be identified as being associated with portions of the energy application zone, and at times, a choice may be made not to transmit energy at such excitation setups. In that case, the amount of electromagnetic energy absorbed in the cavity walls may be substantially small, and thus, the amount of electromagnetic energy absorbed in the object may be substantially equal to the amount of absorbable energy.

In some of the presently disclosed embodiments, a dissipation ratio may be calculated using equation (1):

DR=P_{abs}/Pᵢₙ (1)

wherein P_{abs} is the power absorbed in the cavity holding the object, and Pₘ is the incident power. The dissipated power may be equated with the difference between the incident power and the power detected by sensors in or around the cavity. If these sensors are only the radiating elements, equation (1) may be equivalent to equation (1a):

DR=(Pᵢₙ−P_{rf}−P_{cp})/Pᵢₙ (1a)

where Pₘ represents the electromagnetic energy and/or power supplied to an emitting radiating element 102, P_{rf} represents the electromagnetic energy and/or power reflected/returned at the emitting radiating element, and P_{cp} represents the electromagnetic energy and/or power coupled at those radiating elements that function as receivers. The numerator, (Pᵢₙ−P_{rf}−P_{cp}) may be referred to as “non-detected power”, since this power is not detected to leave the energy application zone, but is known to enter. Alternatively or additionally, the numerator may be referred to as “absorbed power”, since it may provide a good estimation to the absorbed power; an estimation that may be accurate if no power is lost by any mechanism (e.g., cavity walls) other than being absorbed by the object. The terms “non-detected energy” and “absorbed energy” may be similarly used to refer to the difference between incident energy on the one hand, and the sum of reflected and coupled energies on the other hand. DR may be a unit-less value between 0 and 1, and thus may be represented by a percentage number.

Alternatively, or additionally, another kind of dissipation ratio may be calculated using Equation (2a):

Δρ=P_{abs}/(Pᵢₙ−P_{ref}) (2a)

Replacing P_{abs} with (Pᵢₙ−P_{rf}−P_{cp}), as done above may result in equation (2b) for Δρ:

Δρ=(Pᵢₙ−P_{rf}−P_{cp})/(Pᵢₙ−P_{rf}) (2b)

This dissipation ratio may measure the amount of dissipated power (or non-detected power) as a portion of the delivered power, that is, the power that was emitted and did not return to the emitting radiating element. It is noted that the incident, reflected, and coupled powers may also be indicative of the respective energies. This dissipation ratio may be useful to identify frequencies at which the object absorbs a significant portion of the energy delivered to the energy application zone, even if only a small portion of the supplied energy is delivered to the zone, and a large portion is reflected back to or retained at the emitting radiating element, for example, due to poor matching. The use of Δρ may be limited to apparatuses that provide energy via two or more radiating elements, because if only one radiating element exists, no energy may be coupled from one radiating element to another, and Δρ may equal 1 by definition.

For example, consistent with an embodiment which is designed for three antennas 1, 2, and 3, computing subsystem 92 may be configured to determine input reflection coefficients S₁₁, S₂₂, and S₃₃ and the transfer coefficients (which may also be referred to as transmission coefficients) may be S₁₂=S₂₁, S₁₃=S₃₁, S₂₃=S₃₂ based on a measured power and/or energy information during the sweep. Accordingly, the dissipation ratio DR corresponding to antenna 1 may be determined based on the above mentioned reflection and transmission coefficients, according to formula (3):

DR¹=1−(IS₁₁I²+IS₁₂I²+IS₁₃I²). (3)

Similarly, the dissipation ratio Δρ corresponding to antenna 1 may be determined based on the above mentioned reflection and transmission coefficients, according to formula (3a):

Δρ¹=[1−(IS₁₁I²+IS₁₂I²+IS₁₃I²]/(1−|S₁₁|²)=DR¹/(1−|S¹¹|²) (3a)

In some embodiments, a common DR may be defined for the two radiating elements:

DR¹⁺²=P_{abs}/(Pᵢₙ¹+Pᵢₙ)

DR¹⁺²=[(Pᵢₙ¹+Pᵢₙ²)−(Pₒᵤₜ¹+Pₒᵤₜ²)]/(Pᵢₙ¹+Pᵢₙ²)

wherein the Pᵢₙ¹ and Pᵢₙ² are the power (or energy) incident at radiating element 1 and 2, respectively; and Pₒᵤₜ¹+Pₒᵤₜ² are the power (or energy) received at radiating elements 1 and 2, respectively, from the energy application zone.

Because absorbable energy can change based on a host of factors including object position within zone 9, in some embodiments, it may be beneficial to regularly update absorbable energy values and adjust energy application based on the updated absorbable values. These updates can occur multiple times a second, or can occur every few seconds or longer, depending on the rotation frequency of the chamber. In some embodiments, the absorbable energy values are updated and energy application updated at a change frequency higher than the rotation frequency of chamber 10.

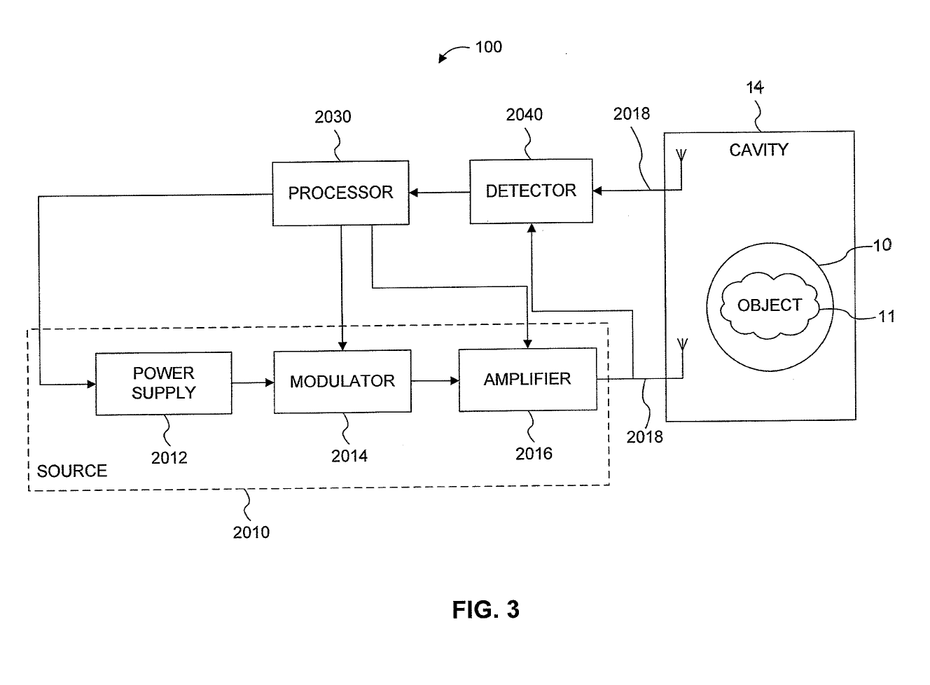

Reference is now made to FIG. 3, which provides a diagrammatic representation of an exemplary apparatus 100 for applying electromagnetic energy to an object, in accordance with some embodiments of the present invention. In some embodiments, apparatus 100 may include a processor 2030 which may regulate modulations performed by modulator 2014. Processor 2030 may make part of controller 101 shown in FIG. 1. In some embodiments, modulator 2014 may include at least one of a phase modulator, a frequency modulator, and/or an amplitude modulator configured to modify the phase, frequency and/or amplitude of an AC waveform generated by power supply 2012. Processor 2030 may alternatively or additionally regulate at least one of location, orientation, and configuration of each radiating element 2018, for example, using an electro-mechanical device. Such an electromechanical device may include a motor or other movable structure for rotating, pivoting, shifting, sliding or otherwise changing the orientation and/or location of one or more of radiating elements 2018.

In some embodiments, apparatus 100 may involve the use of at least one source 2010 configured to deliver electromagnetic energy to the energy application zone. By way of example, and as illustrated in FIG. 3, source 2010 may include one or more RF power supplies 2012 configured to generate electromagnetic waves that carry electromagnetic energy. For example, RF power supply 2012 may include a magnetron configured to generate high power microwave waves. The magnetron may be configured to supply the RF power at a predetermined wavelength or frequency. In some embodiments, one or more magnetrons may be used to supply energy at multiple frequencies and/or phases. For example, the frequency supplied by a magnetron may be controlled by varying the filament current and/or the anode voltage. In some embodiments, RF power supply 2012 may include a semiconductor oscillator, such as a voltage controlled oscillator, configured to generate AC waveforms (e.g., AC voltage or current) with a constant or varying frequency. AC waveforms may include sinusoidal waves, square waves, pulsed waves, triangular waves, or another type of waveforms with alternating polarities. Alternatively, source 2010 may include any other RF power supply, such as electromagnetic field generator, electromagnetic flux generator, solid state amplifier or any mechanism for generating vibrating electrons. In some embodiments, apparatus 100 may include one or more detectors 2040 (e.g., associated with or connected to radiating elements). Detector 2040 may comprise or may be associated with one or more couplers (e.g., dual directional couplers—not illustrated) configured to distinguish between the forward (emitted) and backward (received) energy.

In some embodiments, apparatus 100 may include a phase modulator (which may be included, for example, in modulator 2014) that may be controlled to perform a predetermined sequence of time delays on an AC waveform, such that the phase of the AC waveform is increased by a number of degrees (e.g., 10 degrees) for each of a series of time periods, for example, to carry out a phase sweep. In some embodiments, the phase modulator may receive a target phase from processor 2030, and modulate a signal received from RF power supply 2012 to have the target phase. In some embodiments, processor 2030 may dynamically and/or adaptively regulate modulation based on feedback from the energy application zone. For example, processor 2030 may be configured to receive EM feedback, for example, in the form of an analog or digital feedback signal from detector 2040, indicating an amount of electromagnetic energy received from cavity 14, and processor 2030 may dynamically determine a time delay at the phase modulator for the next time period based on the received feedback signal.

In some embodiments, apparatus 100 may include a frequency modulator (which may be included in modulator 2014). The frequency modulator may include a semiconductor oscillator configured to generate an AC waveform oscillating at a predetermined frequency. The predetermined frequency may be in association with an input voltage, current, and/or other signal (e.g., analog or digital signals). For example, a voltage controlled oscillator may be configured to generate waveforms at frequencies proportional to the input voltage.

Processor 2030 may be configured to regulate an oscillator (not illustrated) to sequentially generate AC waveforms oscillating at various frequencies within one or more predetermined frequency bands. In some embodiments, a predetermined frequency band may include a working frequency band, and the processor may be configured to cause the transmission of energy at frequencies within a sub-portion of the working frequency band. A working frequency band may include a collection of frequencies selected because, in the aggregate, they achieve a desired goal, and there is diminished need to use other frequencies in the band if that sub-portion achieves the goal. Once a working frequency band (or subset or sub-portion thereof) is identified, the processor may sequentially apply power at each frequency in the working frequency band (or subset or sub-portion thereof). This sequential process may be referred to as “frequency sweeping.” In some embodiments, based on the feedback signal provided by detector 2040, processor 2030 may be configured to select one or more frequencies from a frequency band and regulate an oscillator to sequentially generate AC waveforms at these selected frequencies.

Alternatively, or additionally, processor 2030 may be further configured to regulate amplifier 2016 to adjust amounts of energy supplied to radiating elements 2018 (or power levels at which energy is supplied to the radiating elements), based on the feedback signal.

In some embodiments, the apparatus may include more than one source of RF energy. For example, more than one oscillator may be used for generating AC waveforms of differing frequencies. The separately generated AC waveforms may be amplified by one or more amplifiers. Accordingly, at any given time, radiating elements 2018 may be caused to simultaneously transmit electromagnetic waves at, for example, two differing frequencies, to cavity 14.

Processor 2030 may be configured to regulate the phase modulator in order to alter a phase difference between two or more electromagnetic waves supplied to the energy application zone (e.g., by two or more radiating elements). In some embodiments, the source of electromagnetic energy may be configured to supply electromagnetic energy at a plurality of phases, and the processor may be configured to cause the transmission of energy at a subset of the plurality of phases. By way of example, the phase modulator may include a phase shifter. The phase shifter may be configured to cause a time delay in the AC waveform in a controllable manner within cavity 14, delaying the phase of an AC waveform anywhere from between 0-360 degrees.

In some embodiments, a splitter (not illustrated) may be provided in apparatus 100 to split an AC signal, for example generated by an oscillator, into two AC signals (e.g., split signals). Processor 2030 may be configured to regulate the phase shifter to sequentially cause various time delays such that the phase difference between two split signals may vary over time. This sequential process may be referred to as “phase sweeping.” Similar to the frequency sweeping described above, phase sweeping may involve a working subset of phases selected to achieve a desired energy application goal.

The processor may be configured to regulate an amplitude modulator in order to alter the amplitude of at least one electromagnetic wave transmitted (applied) to the energy application zone. In some embodiments, the source of electromagnetic energy may be configured to supply electromagnetic energy to the radiating element(s) in a plurality of amplitudes, and the processor may be configured to cause the transmission of energy at a subset of the plurality of amplitudes. In some embodiments, the apparatus may be configured to supply electromagnetic energy to a plurality of radiating elements, and the processor may be configured to cause energy supply with differing amplitudes simultaneously to at least two radiating elements.

Although FIG. 2 and FIG. 3 represent systems that include two radiating elements (e.g., radiating elements 16, 18; or 2018), it should be noted that any number of radiating elements may be employed, and the circuit may select combinations of excitation setups through selective use of radiating elements. By way of example only, in an apparatus having three radiating elements A, B, and C, amplitude modulation may be performed with radiating elements A and B, phase modulation may be performed with radiating elements B and C, and frequency modulation may be performed with radiating elements A and C. In some embodiments, amplitude may be held constant and field changes may be caused by switching between radiating elements and/or subsets of radiating elements.

An aspect of some embodiments of the invention may include methods and apparatus for processing an object by RF energy. The processing may include drying, in which case, the object may be any wet object, for example, wet garments, wet linen, garbage, fruits, or vegetables.

As used herein, drying an object may include any action that reduces the amount of wetness or dampness associated with the object (e.g., reduces an amount of water held by or associated with the object). For example, the object may include a wet piece of clothing, and drying may include reducing the amount of wetness of the piece of clothing. In another example, the object may include a mass of fruit, and drying may include reducing the water content of this mass. In many cases, drying causes weight reduction of the wet object, due to loss of water. In some embodiments, drying an object may include drying to a predetermined amount or percentage of remaining moisture. For example, drying may include reducing the remaining moisture to 70%, 60%, 50%, 40%, or any other portion of the original amount of moisture, that was associated with the object before drying began.

In some embodiments, the method may include applying RF energy to the inside of a chamber configured to contain the object, e.g., chamber 10. The RF energy may be applied at a plurality of excitation setups. Chamber 10 may be made of a material that allows transmission of RF energy therethrough and, in some cases, absorbs little or none of the applied RF energy. Such a material may be referred to herein as RF-transparent. For some embodiments, RF transparent materials may include any material capable of transferring at least some EM energy in the RF range. Chamber 10 may include wings (not shown) configured to tumble laundry in the chamber. Chamber 10 may also include openings (not shown), e.g., for allowing dampness to leave the chamber and/or for allowing hot dry air into the chamber to facilitate water evaporation from the object. In the present disclosure, air may be considered dry if it is not saturated with water vapor, so it may absorb water from the laundry. In some embodiments, the dry air may include water vapor up to 70%, 50%, or 30% of the saturation concentration of water in air. Similarly, air may be considered hot if its temperature is higher than the laundry temperature. Some exemplary temperatures of hot air may include air at a temperature of 50° C., 70° C., or 80° C. (or within a range greater than 50° C.).

In some embodiments, drying may further include passing air through the drying chamber to remove water vapor from the chamber. The air may be hot to increase its ability to absorb water vapor. In some embodiments, the air may be heated using the power source, amplifier, or any other portion of the apparatus that may provide heat during RF energy application. For example, in some embodiments, the apparatus may include a dummy load configured to absorb RF energy reflected from the energy application zone, e.g., to protect other parts of the apparatus from being damaged by this energy. In some embodiments, heat from the dummy load may be passed to the air, before the air is pumped into the drying chamber to collect water vapor. In some embodiments, the amplifier (e.g., amplifier 2016) may heat during its normal operation, and this heat may be used for heating the air.

Applying RF energy to the inside of a chamber may include applying the RF energy via radiating elements that are inside the chamber, that face the inside of the chamber, or that are otherwise configured to provide RF energy to the inside of the chamber. It is noted that applying RF energy to the inside of the chamber may result in application of some amount of energy outside the chamber. For example, the chamber may be RF-transparent, and energy applied to the interior thereof may extend outside the chamber through the chamber's walls. In some embodiments, the chamber may be provided inside an RF-reflective cavity (e.g., cavity 14), which reflects most of the energy exiting from the chamber back to the interior of the chamber. Still, some energy may find its way outside the cavity, for example, by leaking via a door in the cavity, or by being absorbed in cavity wall or in a dummy load, provided to protect amplifiers from receiving energy reflected from the chamber or from the cavity, or by any other way.

The chamber (e.g., chamber 10) may be configured to contain the object. For example, the chamber may have a size and an opening with dimensions allowing the wet object to be inserted into the chamber and retained in the chamber. In some embodiments, the chamber may be sized such that a significant portion of the chamber remains empty when the object is in the chamber, for example, 1/20, 1/10, or ⅓ of the space inside the chamber may remain free when the wet object is in the chamber. This may facilitate water removal by dry air pumped into the chamber, over the object to be dried, and out of the chamber. A suitable ratio between the object size and the chamber size may also facilitate pressing the object against interior walls of the chamber by centrifugal force that may be applied on the object when the chamber rotates. Such pressing may facilitate water removal.

In some embodiments, the apparatus may be operated at a predetermined average DR (or other value indicative of energy absorbable in the object) over the available excitation setups. In some embodiments, a low average DR of, for example, 0.6 or 0.5 or less may be used. Average DR may depend on an amount of water present in the chamber, including the object. For example, for certain embodiments, an average DR of 0.6 or less may occur when the amount of water in the chamber is low, e.g., less than about half a liter or less. Some scenarios, in which the amount of water may be low, include final drying stages, after much of the water has been removed; and drying a small object, for example, drying laundry with a weight that is half or less than a weight of laundry for which the dryer is designed. For example, drying 3 Kg of laundry in a laundry dryer designed to dry 6 Kg of laundry may result in low average DR.

In some embodiments, applying energy only at well absorbed excitation setups (e.g., only at excitation setups that have a DR value higher than 90% or only at the excitation setups having the highest available DR values) and updating the excitation setup at which energy is applied several times per chamber rotation, may result in highly efficient drying even when the average DR is small. This may be advantageous in drying small objects (e.g., smaller than half the size for which the dryer is designed). This may also be advantageous in final stages of drying, where most other dryers become inefficient because of the difficulty in targeting the energy into the water. For example, hot-air dryers have difficulty in contacting the hot air with the small and dispersed amounts of water in the almost dry laundry, and RF-based dryers that do not update the applied excitation setups at sufficient rate may find it difficult to use excitation setups that are absorbed efficiently along a significant portion of the drying time.

The chamber may be configured to rotate with the object inside. This may require the chamber to be installed on an axis, and may also include connecting the chamber to a motor via a gear. The gear may be configured to allow rotating the chamber at a predetermined rotation frequency (for example, 20, 25, 30, 35, or 40 rotations per minutes (RPM)), or may be configured to allow rotating the chamber at an adjustable rotation frequency. For example, the rotation frequency may change (e.g., may be controlled and changed by a controller) in accordance with the weight of the object, the amount of moisture, or according to a stage in the drying process. It is noted that the chamber may be at least partially made of RF-transparent material or partially made of RF-transparent material (e.g., one or more RF transparent windows may be provided in the camber wall), so that RF energy applied by radiating elements placed outside of the chamber may penetrate to the inside of the chamber. The radiating elements may be static, and may be contained in an RF-reflective cavity, such that the cavity prevents the RF energy applied to the chamber (or at least most of this RF energy) from escaping outside the cavity, and allows the chamber to rotate while the radiating elements are static.

In some embodiments, the method may include altering one or more aspects of the RF energy application at a change frequency higher than the rotation frequency. The one or more aspects of the RF energy application may include an excitation setup, a power level at which energy is applied, a time period along which energy is applied, an amount of energy applied, any combination thereof, or any other aspect of the energy application. Altering an aspect of the RF energy application may include changing a value of the altered aspect. For example, changing a frequency of RF radiation from one value (e.g., 820 MHz) to another value (e.g., 825 MHz), changing a power level (e.g., from 100 W to 500 W), etc. In some embodiments, the change frequency may correspond to a number of times the one or more aspects of the RF energy application are changed per time unit (e.g., minute, half-minute, etc.). For example, if altering the one or more aspects of the RF energy application consists of changing a phase difference between RF waves supplied to two radiating elements, the change frequency may be the number of times the phase difference changes during one minute of drying.

In some embodiments, chamber rotation may be intermittent, for example, the chamber may rotate in one direction (e.g., clockwise), pause, and then rotate in the opposite direction (e.g., counter clockwise). In some embodiments, the rotation frequency may correspond to the number of rotations during a time period that includes one or more pauses. In other embodiments, the rotation frequency may correspond to the number of rotations during a time period between two pauses. In some embodiments, energy application may be altered mainly or only when the chamber is in motion, and when the chamber pauses, energy application may be altered less frequently or not at all. In some embodiments, energy may be applied at multiple excitation setups before alteration, and the alteration may include selecting one or more of the excitation setups for further energy application. Additionally, or alternatively, the alteration may include altering a power level, a time duration, or any other aspect, at which one or more of the excitation setups are applied.

In some embodiments, the method may include adjusting an amount of RF energy absorbed by the object, e.g., by altering the one or more aspects of the RF energy application. For example, the excitation setups may be altered to increase or maximize energy absorption in the energy application zone. Altering the excitation setup applied to maximize energy absorption may result in adjusting the amount of RF energy absorbed by the object to be maximal, at least in the instant following the altering. Thus, in some embodiments, the one or more aspects of the RF energy application may be altered such that energy absorption inside the chamber may occur at a level after the altering that is higher than a level of energy absorption inside the chamber before the altering. Between two alterations, the rate of energy absorption may change (e.g., drop), for example, due to movement of the object in the chamber and change in the overlap between the object and the RF field pattern(s) excited in the chamber. In some embodiments, the rate of absorbed energy after an alteration may be monitored and may be compared to a predetermined threshold. When such a threshold is crossed (e.g., if the energy absorption rate falls below the threshold), then steps may be taken to identify a new excitation setup offering a higher (or maximal) rate of energy absorption. The minimal threshold may correspond to a certain DR value (e.g., 0.9, 0.85, 0.8, etc.). In some embodiments, the minimal threshold may be relative and may, for example, correspond to an observed drop in DR of more than 10%, 15%, 20%, etc.

The amount of energy absorbed in the chamber (or in the object) may be estimated based on values indicative of energy absorbable by the object, such as, for example, DR and/or Δρ, discussed above. The amount of energy absorbed inside the chamber may include energy absorbed in the object, in water inside the object, in moisture around the object, or any other way inside the chamber or outside the chamber. In some embodiments, the amounts of energy absorbed in all these places are collectively referred to as amounts of energy absorbed inside the chamber.

In some embodiments, the one or more aspects of the RF energy application may be altered at a change frequency higher than the rotation frequency of the chamber. For example, in some embodiments, the chamber may rotate at rotation frequency of between about 20 and about 60 RPM, and the aspect(s) of RF energy application may be altered at intervals of 100 ms (i.e., at a frequency of 600 times per minute). In this example, the change frequency is larger than the rotation frequency by a factor of between about 30 (if the chamber rotates at about 20 RPM) and about 10 (if the chamber rotates at about 60 RPM).

Without being bound to theory, it is suggested herein that the effectiveness of the RF energy application in evaporating water from the object may depend, for example, on an overlap between the applied electromagnetic field and the object. Since the chamber rotates, the object moves, and updating the excited fields to follow this movement may increase the energetic efficiency of the drying process. Accordingly, energy absorption efficiency may increase when the change frequency is correlated to the rotation frequency, for example, when change frequency is larger than the rotation frequency by at least a factor of 2. In some embodiments, one or more characteristics of the RF energy application may be altered at a frequency larger than the rotation frequency by a factor of 10, 15, 20, or 100.

As noted, in some embodiments, altering the characteristics of the RF energy application may increase a rate of energy absorption in the object in comparison with a rate of energy absorption before altering. Additionally, or alternatively, altering one or more characteristics of the RF energy application at a change frequency higher than the chamber's rotation frequency may increase energetic absorption efficiency of the drying process by 20% or more in comparison with an energy absorption efficiency achieved with a change frequency equal to the rotation frequency. In some embodiments, a change frequency higher than the rotation frequency by a factor of between about 10 and about 20 may be used.

Such an increase in drying efficiency may occur, for example, when the application of RF energy to the chamber occurs at one or more excitation setups; and alteration of the one or more characteristics of the energy application includes changing at least one of these excitation setups, e.g., to excitation setup(s) offering a higher rate of energy absorption or absorption efficiency. For example, in some embodiments, energy may be applied at a single excitation setup, and the applied excitation setup may be altered at the change frequency, such that at least in the beginning of each period that follows an alteration, the applied excitation setup may be absorbed most efficiently, e.g., at an efficiency larger than a predetermined threshold, for example, larger than 70%, 80%, 90%, or 99%. In another example, at least in the beginning of each period that follows an alteration, the applied excitation setup may be absorbed more efficiently than any other excitation setup (or most excitations setups) available to the apparatus.

In some embodiments, the application of RF energy may include RF energy application at two or more pilot excitation setups. The pilot excitation setups may be applied at a relatively low power level, for example, at a power level at least sufficient to allow receiving electromagnetic (RF) feedback in response to the application of the pilot excitation setups. The pilot excitation setups may be applied for collecting feedback without heating. The pilot excitation setups may be applied for a relatively short average time per excitation setup, for example, for the minimal length allowing receipt of the feedback at each of the excitation setup. Shortening the time spent on pilot excitation setup may allow lengthening the time spent on heating. Thus, in some embodiments, RF energy may be applied at the selected excitation setups for a total time duration larger than a total time duration for which RF energy is applied at the pilot excitation setups. The total time duration spent at selected excitation setups, e.g., for heating, may be larger by a factor of 5, 10, 20, or any larger or intermediate number, than the time duration spent to apply pilot excitation setups. In some embodiments, an average time duration of energy application per pilot excitation setup is shorter than an average time duration of energy application per selected excitation setup, for example, by a factor of 10, 20, 50, or 100.

The pilot excitation setups may be applied for a first average duration per excitation setup (for allowing receipt of the feedback at each of the excitation setup), and the selected excitation setups may be applied at a second average duration per excitation setup, wherein the second average duration is higher than the first average duration and the one or more selected excitation setups include one or more of the pilot excitation setups.

In some embodiments, one or more aspects of energy application at a given excitation setup (e.g., amount of energy, power level at which energy is applied, etc.) may depend on electromagnetic (EM) feedback received at the same excitation setup, at a different excitation setup, or over multiple excitation setups.

In some embodiments, the pilot excitation setups may be used for sensing only. In some embodiments, the pilot excitation setups may be also used for evaporating water from the object. Using pilot excitation setups to evaporate water, however, may impact energetic efficiency, since the extent to which the pilot excitation setups are absorbed, on the average, may be lower than the extent to which selected excitation setups (e.g., setups exhibiting higher than average energy absorption characteristics) may be absorbed, particularly if the selection is based on an extent to which energy is absorbed at the pilot excitation setups. In some embodiments, pilot excitation setups may be distinguished from other excitation setups in that electromagnetic feedback responsive to the application of the pilot excitation setups may be collected and used for determining one or more aspects of the energy application characteristics.

In some embodiments, an average DR over the pilot excitation setups may be smaller than over the selected excitation setups. The same may be true for other values indicative of energy absorbable in the object. This may be the case, for example, when excitation setups are selected according to their DR values. For example, when excitation setups associated with the highest DR values are selected, when excitation setups associated with DR values higher than a threshold are selected, and when such selections are made only among excitation setups associated with absorption peaks having Q factors of some predetermined range, as discussed herein, an average DR over the pilot excitation setups may be smaller than over the selected excitation setups.

After energy is applied at the pilot excitation setups, energy application at selected excitation setups may commence. Selection of excitation setups may be from among the pilot excitation setups, for example, based on energy absorption characteristics of the pilot excitation setups. Energy absorption characteristics may include, for example, values indicative of energy absorbable in the object, a Q factor of absorption peaks associated with the excitation setups, or any other value that may characterize energy absorption at the various excitation states. Additionally, or alternatively, the selected excitation setups may be applied at a power level higher than that used with the pilot excitation setups. For example, in some embodiments, energy applied at the selected excitation setups may be applied at the highest power available to the apparatus to maximize time efficiency of the drying process. In other examples, less than maximal available power may be applied at the selected excitation setups. Additionally, or alternatively, the selected excitation setups may be applied for longer duration than that used with the pilot excitation setups, for example, by a factor of 5, 10 or more.

In some embodiments, the power level at which the selected excitation setups are applied is higher than the power level at which the pilot excitation setups are applied by a factor of 2 or more, e.g., by a factor of about 5 or more. In some embodiments, moving from pilot excitation setups to selected excitation setups may be considered to constitute an alteration of one or more aspects of the RF energy application, and thus, may occur at a rate (frequency) larger than the rotation frequency of the chamber.

In some embodiments, the selected excitation setups may be selected from among the pilot excitation setups such that the selected setups absorb energy more efficiently than other pilot excitation setups. For example, there may be one selected excitation setup, and it may be the pilot excitation setup at which energy absorption was higher than in any of the other pilot excitation setups available to the apparatus or within a group of pilot excitations setups for which feedback was generated or evaluated. In other embodiments, a plurality of selected excitation setups may be used, and each of the plurality of selected excitation setups may exhibit an energy absorption level/rate/efficiency higher than pilot excitation setups not among the selected excitation setups (e.g., those pilot excitation setups not chosen for use as a selected excitation setup)

In some embodiments, the selected excitation setups may be associated with RF energy absorption peaks having a Q factor less than a predetermined threshold, for example, less than 200. The Q factor may correspond to a measure of the breadth of the peak, with broader peaks having smaller Q factors. In the context of the present disclosure, the term Q factor may refer to breadth of an absorption peak regardless of the c-FAP along which the absorption changes. For example, the peak may be along a frequency c-FAP, along a phase c-FAP, or along any other c-FAP. In some embodiments, the Q factor may be equated with a ratio between the central c-FAP value of the peak and the width of the peak at half the peak's maximum. For example, in some embodiments, the Q factor may be equated with a ratio between the central frequency value of the peak and the width of the peak (along the frequency c-FAP) at half the peak's maximum. In some embodiments, the Q factor may be equated with a ratio between the central phase of the peak, e.g., in a DR vs. phase graph, and the width of the peak along the phase c-FAP at half the peak's maximum.

Such embodiments may be advantageous when sharp peaks (e.g., peaks having Q factor larger than 200 or other predetermined threshold) may be associated with energy absorbed in the cavity surrounding the chamber or other metallic structures, and not necessarily absorbed at the object. When this is indeed the case, applying energy at excitation setups associated with such sharp peaks may transfer only a small portion of the applied energy, if any, to the object. In some embodiments, the selected excitation setups include those associated with the strongest energy absorption and with absorption peaks having a Q factor smaller than a threshold.

An aspect of some embodiments of the invention may include a processing method, which includes excitation setups selection, and application of RF energy at the selected excitation setups. The method may include applying energy and selecting excitation setups at a rate of two or more times during a single rotation of the drying chamber. Selecting and applying twice during a single rotation may ensure that at least once during the rotation, the method will allow a change of the applied excitation setup(s). A larger number of selections and applications per chamber rotation may allow more frequent changes in applied excitation setups. Each time a selection is made, the selected excitation setup may be different from the one applied before the selection, and thus, a change of excitation setup may occur. Generally, the more frequent the selection is, the more efficient the energy application may be.

Notwithstanding, there is an upper limit to the number of selections and applications it may be advisable to carry out during a single rotation. For example, at some stage, the movement of the object inside the chamber between two selections may be too small to justify adjustment of the applied excitation setup to follow such a small movement. In another example, when the selection is based on feedback, collecting the feedback may take time, and in some embodiments selection takes place at a frequency that allows time spent on collecting feedback to be shorter than time spent on energy application for heating. In some embodiments, the heating time may be longer than a feedback collection time, for example, by a factor of 2, 5, 10, 20, etc. This may set an upper limit to the number of selections and applications during a single rotation. For example, if a single rotation takes two seconds, feedback collection takes 10 ms, and the desired ratio between feedback collection and energy application is 1:10, approximately 20 selections and applications during a single rotation may constitute a practical upper limit to the number of selections/applications that may occur during one rotation. This is so because each selection and application may take at least 0.11 seconds, and 2/0.11 is about 20.

In some embodiments, selection and application may be repeated twice or more during some of chamber rotations included in a drying process. For example, two or more selections and applications may be accomplished during each rotation of the chamber, during each second rotation of the chamber, during at least half of the rotations of the chamber, etc.

The method may further include receiving electromagnetic (EM) feedback from the chamber. In such embodiments, selection of the one or more excitation setups may be based on the EM feedback.

In some embodiments, selecting the one or more excitation setups may include causing application of RF energy at two or more pilot excitation setups; receiving EM feedback from the chamber; and selecting the one or more excitation setups from among the pilot excitation setups based on the EM feedback.

In some embodiments, feedback may be received also in response to use of the selected excitation setups, and alteration may occur whenever energy absorption decreases by at least a predetermined factor, for example, by at least 10%. For example, an excitation setup may be selected, and then energy at high power may be applied at the selected excitation setup. During energy application at high power, feedback may be received, and when an absorption efficiency at the selected excitation setup drops to below a predetermined value, energy application may switch to pilot excitation setups, for example, at low power, for selecting a new excitation setup from a plurality of pilot excitation setups.

An aspect of some embodiments of the invention may include an apparatus configured to carry out one or more of the above-described methods. For example, consistent with some embodiments of the present invention, an apparatus for drying an object may include a source of RF energy; and a controller (e.g., controller 101 or processor 2030). The controller may be configured to cause the source of RF energy to apply RF energy to a chamber; and alter one or more aspects of the RF energy application to the chamber at a change frequency higher than the rotation frequency. The chamber may be configured to hold the object to be dried and to rotate at the rotation frequency. Altering the one or more aspects of the RF energy application may include changing an average amount of energy applied at each excitation setup by a factor of at least two. For example, changing the average amount of energy may include applying energy at a different power level, for a different time duration, or a combination thereof. The average amount of energy applied at each excitation setup may be calculated based on the sum of applied amounts of energy. In some embodiments, the sum may be further divided by the number of excitation setups applied. The altering may be performed such that the sum of applied amounts of energy is higher by a factor of at least two after an alternation. For example, before an alteration, 10 W may be applied for 1 ms at each excitation setup; and after alteration, 300 W may be applied for 15 ms at each excitation setup, such that the average amount of energy applied at each excitation setup increases by a factor of 450.

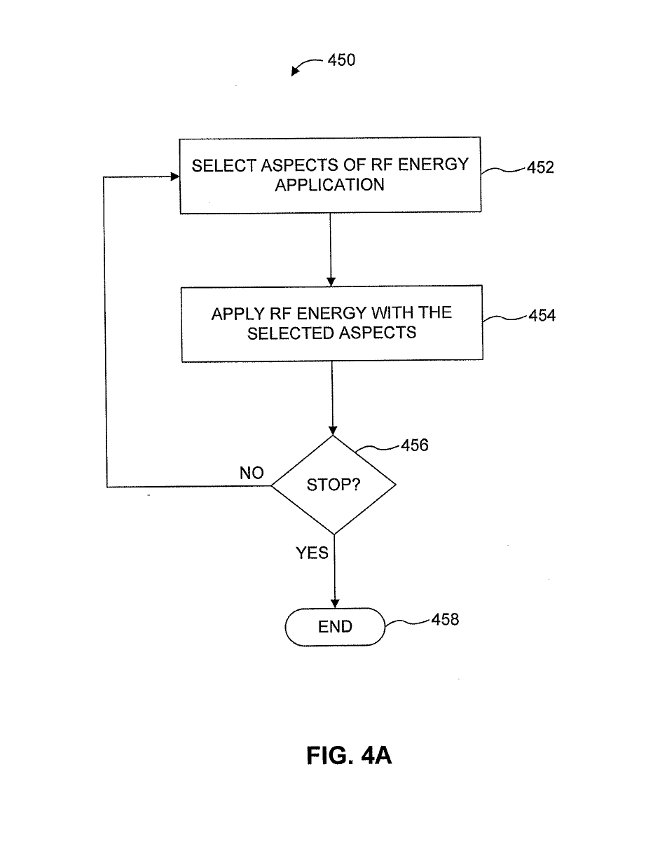

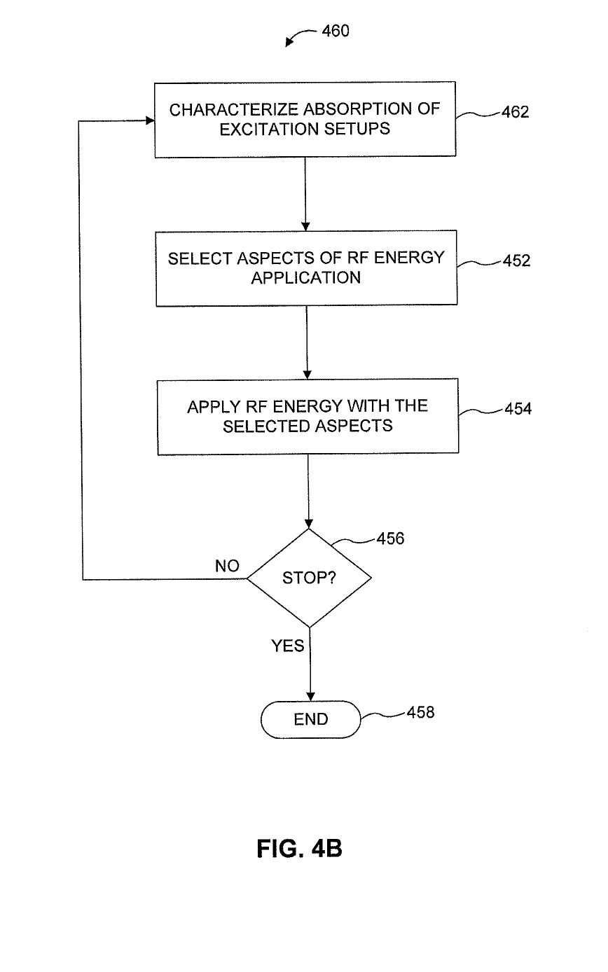

Reference is now made to FIG. 4A, which is a flow chart of steps in a method 450 of processing an object, in accordance with some embodiments of the invention. In step 452, one or more aspects of RF energy to be applied to the inside of a drying chamber may be selected. The chamber may include, for example, chamber 10 of FIG. 1, 2, or 3, or another chamber configured to contain the object to be processed. The one or more aspects may be selected from available aspects. For example, a selected aspect may include an excitation setup selected from the excitation setups available to the dryer. In another example, a selected aspect may be a power level at which RF energy is applied, selected from available power levels. In another example, a selected aspect may be a time duration, for which RF energy is applied at each excitation setup.

In step 454, energy may be applied according to the aspects selected in step 452, for example, at the excitation setups, time durations, and/or power levels selected in step 452.

In step 456, one or more stopping criterions may be checked to determine whether to stop the process. If met, the drying process may end at step 458. Otherwise, the drying process may continue, e.g., by returning to step 452. In some embodiments, the stopping criterion may include a predetermined drying period, and after the predetermined period has lapsed, drying may be stopped. In some embodiments, humidity in the chamber may be measured, and the process may be stopped when humidity decreases to below a predetermined threshold, e.g., below 50%, 40%, or 30% of humidity at commencement of the drying process. In some embodiments, a stopping criterion may be related to an average DR over all or some of the excitation setups available to the dryer. For example, in some embodiments, drying may stop when the average DR decreases to below 0.35. In some embodiments, the stopping criterions may include receiving a stop signal from outside the apparatus, for example, from a user. The user may send a stop signal, for example, by pushing a stop button.

Steps 452 and 454 may be repeated a number of times, before a stopping criterion is met. The rate at which these steps are repeated, may be referred to as a repetition rate at which one or more aspects of the energy application changes from one effective energy application event (454) to another.

Steps 452 and 454 may take place when the chamber rotates. In some embodiments, the rotation frequency of the chamber is lower than the change rate. For example, the change rate may be larger than the repetition rate by any factor larger than 1, for example, 1.5, 2, 10, 20, or 50. In some embodiments, the repetition rate may be larger than the rotation rate of the chamber. In some embodiments, both the change rate and the repetition rate may be larger than the rotation rate of the chamber; in some embodiments, only the repetition rate is larger than the rotation rate.

In succeeding repetitions of step 454, RF energy may be applied to the inside of a drying chamber, with one or more aspects of the RF energy application changed with respect to energy application in a preceding repetition of step 454. For example, in a first repetition, energy may be applied at a first excitation setup, and in a second repetition, energy may be applied at a second excitation setup. Nevertheless, some repetitions may not be accompanies by changes, since it may happen that in two consecutive repetitions of step 452 the same aspects of RF energy application are selected. In some embodiments, the chamber may rotate at a rotation frequency, and the rate of changes of one or more aspects of the applied RF energy may be larger than the rotation frequency. For example, the chamber may rotate at 25 RPM, 30 RPM, 40 RPM, 50 RPM, or any intermediate rotation frequency, and one or more aspects of the applied RF energy may change at a rate of 100, 200, 400, 600, 1000, or any intermediate number of changes per minute. The number of changes per chamber rotation may be a number larger than 1, for example, 1.5, 10, 20, 50, or any intermediate number.

In some embodiments, the change in the at least one aspect of the applied RF energy may be such that the rate of RF energy absorbed changes (e.g., increases). For example, FIG. 4B is a flow chart of a method 460 of RF energy application according to some embodiments of the invention. Method 460 is similar to method 450, but before each repetition of a selection step 452, there may be a characterization step, 462, at which values indicative of energy absorption at the cavity in two or more pilot excitation setups may be determined. Then, at step 452, energy application aspects may be selected based on the characterization. For example, in some embodiments, in step 452, aspects of energy application may be selected such that energy is applied at excitation setups that were found in the characterization step to be absorbed more or most efficiently. The characterization step, 462, may include application of smaller amounts of at pilot excitation setups than the amount of energy applied at step 454. The amount of energy applied may be smaller by a factor of 2 or more, for example by a factor of 2, 4, 10, 50, 100, or 1000. This may be the case for the total energy applied at all the pilot excitation setups compared to the total energy applied at all the excitation setups used for heating. In some embodiments, this may be the case for the energy applied at each excitation setup, and in some embodiments, this may be the case for an average amount of energy applied per excitation setup in step 462 compared to step 454. Lower amounts of energy may be applied by energy application at power levels lower than those used in energy application steps 454, for example, by factor of 2 or more, and/or by energy application for shorter time duration. In method 460, at each repetition of step 454, energy may be applied at one or more excitation setups absorbed more or most efficiently during the preceding characterization step 462. Accordingly, in some embodiments, altering the one or more aspects of the RF energy application between two subsequent repetitions of steps 452 may result in an increase of energy absorption inside the chamber after the altering in comparison to energy absorption inside the chamber before the altering.

### Examples

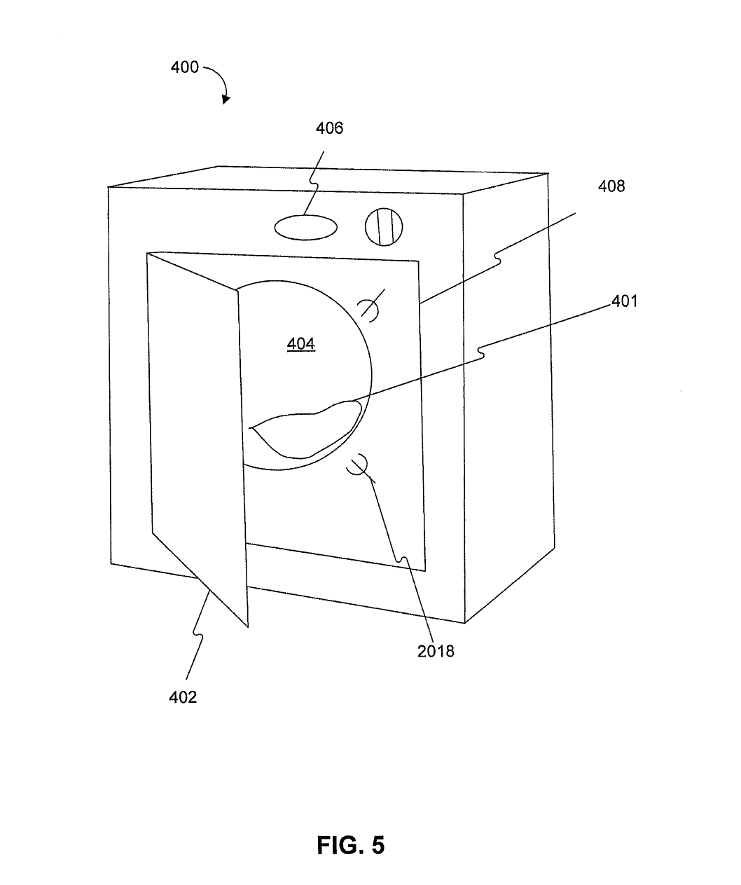

FIG. 5 provides a diagrammatic representation of a laundry dryer 400. To dry laundry with dryer 400 a user may open door 402, put the wet laundry 401 in chamber 404, close the door, and push the “start” button 406, just like in a conventional domestic laundry dryer. Chamber 404 may be inside cavity 408.

Similar to what occurs in a conventional dryer, when the “start” button is pushed, a motor starts rotating chamber 404, and dry air is passed through chamber 404. During its passage through the chamber, the dry air evaporates water and increases in humidity. In addition, the rotation of the chamber moves the laundry to expose differing portions thereof to the dry air.

At about the same time, source 2010 (FIG. 3) may start supplying RF energy at various pilot frequencies to radiating elements 2018. For sake of simplicity of the drawing FIG. 5 does not show apparatus components connected to the radiating elements. Such components are presented, however, in FIG. 3. The pilot frequencies may include frequencies between 800 MHz and 1000 MHz at 4 MHz steps. In this example, 51 pilot frequencies may be used. The power level, at which RF energy is applied at the pilot frequencies, may be relatively low, for example, 100 W or less. Sweeping over the 51 frequencies may take about 10 ms, allowing about 0.2 ms energy application per frequency.

Processor 2030 may receive, via radiating elements 2018 and detector 2040, feedback indicative of the effect RF energy application has on the wet laundry at each of the pilot frequencies, for example, in the form of a table of DR values versus frequencies.

Processor 2030 may select (e.g., from the table) the frequency associated with the largest DR value and may cause source 2010 to supply energy at the selected frequency at relatively high power, for example, 500 W, and supply it to radiating element 2018. Energy application at the selected frequency may last for about 90 ms. In this example, the energy supplied during a heating cycle is 500 W×0.09 sec=45 joule, while the energy supplied during the characterization cycle is 100 W×0.01 sec=1 joule. This factor of 45 includes a factor 9 in energy application duration and factor 5 in power level.

Then, processor 2030 may cause source 2010 to again supply energy at the pilot frequencies at the lower power, receive feedback at each frequency, select a frequency according to the feedback received responsive to this energy application, and cause the source to supply energy at high power at the selected frequency for another period of about 90 ms, and so on, at a repetition rate of 10 times per second (10 Hz). If at each period a different frequency is selected, the change frequency is also 10 Hz.

In the chamber, the laundry moves due to the chamber rotation at a rotation frequency of about 30 RPM (i.e. 0.5 Hz). For optimal results, the change frequency may be larger than the rotation frequency, for example, by a factor of about 20, as in the present example.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the invention, as claimed. For example, one or more steps of a method and/or one or more components of an apparatus or a device may be omitted, changed, or substituted without departing from the scope of the invention. Thus, it is intended that the specification and examples be considered as exemplary only, with a true scope of the present disclosure being indicated by the following claims and their equivalents.

1. A method of processing an object by application of RF energy, the method comprising:
selecting, from among a plurality of excitation setups, one or more excitation setups for RF energy application to a rotating chamber configured to contain an object to be processed; and
applying RF energy at the one or more selected excitation setups, wherein the selecting and applying occurs at least twice during a single rotation of the chamber.

2. The method of claim 1, wherein the selecting and applying occurs at least twice during each of at least half of the rotations of the chamber.

3. The method of claim 1, wherein the selecting and applying occurs at least 10 times during a single rotation of the chamber.

4. The method of claim 1, wherein the selecting and applying occurs at least 10 times during each of at least half of the rotations of the chamber.

5. The method of claim 1, further comprising receiving electromagnetic (EM) feedback from the chamber, and wherein selecting the one or more excitation setups is based on the EM feedback.

6. The method of claim 1, wherein the one or more excitation setups are selected based on RF energy absorption characteristics of the plurality of excitation setups.

7. The method of claim 1, wherein the one or more selected excitation setups have RF energy absorption levels higher than other excitation setups included in the plurality of excitation setups.

8. The method of claim 1, wherein the one or more selected excitation setups have RF energy absorption levels higher than any of the other excitation setups of said plurality.

9. The method of claim 1, wherein selecting the one or more excitation setups comprises:
causing application of RF energy at two or more pilot excitation setups;
receiving EM feedback from the chamber; and
selecting the one or more excitation setups from among the pilot excitation setups based on the EM feedback.

10. The method of claim 9, wherein:
causing application of RF energy at two or more pilot excitation setups comprises applying RF energy at less than a first power level to the two or more pilot excitation setups; and
applying the RF energy at the one or more selected excitation setups comprises applying RF energy at the selected excitation setups at a power level higher than a second power level that is higher than the first power level.

11. The method of claim 9, wherein the EM feedback is indicative of an extent to which RF energy applied at the two or more pilot excitation setups can be absorbed in the chamber.

12. The method of claim 11, wherein the selected one or more excitation setups include those that, based on the EM feedback, exhibit energy absorbable values in the chamber greater than the pilot excitation setups not included in the one or more excitation setups.

13. The method of claim 9, wherein the one or more selected excitation setups are associated with RF energy absorption peaks having widths greater than a predetermined threshold.

14. An apparatus for processing an object by RF energy applied at a plurality of excitation setups the apparatus comprising:
a controller configured to:
select one or more excitation setups, from among a plurality of pilot excitation setups, for applying RF energy to a rotating chamber; and
cause a source of RF energy to apply RF energy at the one or more selected excitation setups, wherein the controller is configured to both select the one or more excitation setups and cause the source of RF energy to apply RF energy to the one or more selected excitation setups at least twice during a single rotation of the rotating chamber.

15. The apparatus of claim 14, wherein the controller is configured to both select the one or more excitation setups and cause the source of RF energy to apply RF energy to the one or more selected excitation setups at least twice during at least half of the rotations of the rotating chamber.

16. The apparatus of claim 14, wherein the controller is configured to both select the one or more excitation setups and cause the source of RF energy to apply RF energy at the one or more selected excitation setups at least 10 times during a single rotation of the rotating chamber.

17. The apparatus of claim 14, wherein the controller is configured to both select the one or more excitation setups and cause the source of RF energy to apply RF energy to the one or more selected excitation setups at least 10 times during at least half of the rotations of the rotating chamber.

18. The apparatus of claim 14, wherein the controller is further configured to receive electromagnetic (EM) feedback from the rotating chamber and select the one or more excitation setups based on the EM feedback.

19. The apparatus of claim 14, wherein the controller is configured to select the one or more excitation setups based on RF energy absorption characteristics associated with the plurality of excitation setups.

20. The apparatus of claim 14, wherein the one or more selected excitation setups are each associated with RF energy absorption levels higher than RF energy absorption levels of other excitation setups of said plurality of pilot excitation setups not among the one or more selected excitation setups.

21. The apparatus of claim 14, wherein the controller is configured to:
cause application of RF energy at two or more pilot excitation setups;
receive EM feedback from the chamber; and
select the one or more selected excitation setups from among the pilot excitation setups based on the EM feedback.

22. The apparatus of claim 21, wherein the controller is configured to cause application of RF energy at the two or more pilot excitation setups at less than a first power level and apply the RF energy at the one or more selected excitation setups at a second power level that is higher than the first power level.

23. The apparatus of claim 18, wherein the feedback is indicative of an extent to which RF energy applied at the plurality of pilot excitation setups can be absorbed in the chamber.

24. The apparatus of claim 21, wherein the controller is configured to select the one or more excitation setups based on whether the one or more excitation setups are associated with RF energy absorption peaks having widths greater than a predetermined threshold.

25. The apparatus of claim 14, further comprising the source of RF energy.

26. The apparatus of claim 14, wherein the apparatus is a dryer.

27. The apparatus of claim 14, wherein the pilot excitation setups include excitation setups that differ from each other in a phase difference between emissions of two radiating elements.

28. The apparatus of claim 14, wherein the controller is configured to cause application of RF energy at the selected excitation setups for a total time duration larger by at least a factor of 5 than a total time duration for which RF energy is applied at the pilot excitation setups.

29. The apparatus of claim 14, wherein an average time duration of energy application per pilot excitation setup is at least 10 times shorter than an average time duration of energy application per selected excitation setup.

30. The apparatus of claim 14, wherein the applied RF energy falls only within one or more ISM frequency bands.
